(19) United States
(12) Patent Application Publication
(10) Pub. No.: US 2025/0366518 A1
(43) Pub. Date: Dec. 4, 2025

(54) AEROSOL GENERATING DEVICE COMPRISING WICK

(71) Applicant: KT&G CORPORATION, Daejeon (KR)

(72) Inventors: Won Kyeong LEE; Min Kyu KIM, Seoul (KR); Paul Joon SUNWOO, Seoul (KR)

(73) Assignee: KT&G CORPORATION, Daejeon (KR)

(21) Appl. No.: 18/876,381

(22) PCT Filed: Oct. 19, 2023
(86) PCT No.: PCT/KR2023/016225

§ 371 Date: Dec. 18, 2024

(30) Foreign Application Priority Data
Oct. 24, 2022 (KR) 10-2022-0137077

(51) Int. Cl. A24F 40/44; A24F 40/10; A24F 40/42; A24F 40/465; A24F 40/60; H05B 3/20

(52) U.S. Cl. CPC A24F 40/44; A24F 40/10; A24F 40/42; A24F 40/465; A24F 40/60; H05B 3/20

(57) ABSTRACT

The aerosol generating device includes a wick including a first end portion, a second end portion opposite to the first end portion, an extension extending between the first end portion and the second end portion, and a heating element disposed inside the extension and configured to generate heat by surface plasmon resonance (SPR).

### TECHNICAL FIELD

The disclosure relates to an aerosol generating device, for example, an aerosol generating device comprising a wick.

### BACKGROUND ART

In general, aerosol generating devices heat a target (e.g., aerosol generating material) to generate an aerosol. For example, heat may be generated by supplying electrical energy to an electrically resistive element. In another example, heat may be generated by electromagnetic coupling between a coil and a susceptor. The above description is information the inventor(s) acquired during the course of conceiving the present disclosure, or already possessed at the time, and is not necessarily art publicly known before the present application was filed.

### DISCLOSURE OF THE INVENTION

### Technical Problem

An aspect of the disclosure may provide an aerosol generating device that increases atomization efficiency.

### Solution to Problem

According to an aspect, there is provided a wick for an aerosol generating device, wherein the wick includes a first end portion, a second end portion opposite to the first end portion, an extension extending between the first end portion and the second end portion, and a heating element disposed inside the extension and configured to generate heat by surface plasmon resonance (SPR).

The extension may include a plurality of fiber strands, and the heating element may be surrounded by the plurality of fiber strands.

The extension may include a hollow portion and a body portion configured to form the hollow portion, and the heating element may be disposed in the hollow portion.

The wick may include a plurality of fiber strands disposed in the hollow portion and configured to surround the heating element.

The wick may include an opening disposed in the extension.

The wick may include a light collector disposed in the opening.

The wick may include a light diffuser disposed in the opening.

The heating element may include a substrate and a plurality of metal particles disposed on the substrate.

According to another aspect, there is provided an aerosol generating device including the above-described wick and a light source configured to emit light toward the wick.

The aerosol generating device may include a reservoir configured to contain a liquid composition, wherein at least one end portion of the first end portion or the second end portion may be connected to the reservoir.

The aerosol generating device may include a reflector disposed in the extension and configured to reflect light toward the heating element.

### ADVANTAGEOUS EFFECTS OF INVENTION

According to an embodiment, the size of a component (e.g., a battery) in an aerosol generating device may be reduced. According to an embodiment, a heating-related element (e.g., a Pogo™ pin) may be removed from an aerosol generating device. The effects of an aerosol generating device according to an embodiment are not limited to the above-mentioned effects, and other unmentioned effects can be clearly understood from the following description by one of ordinary skill in the art.

### BRIEF DESCRIPTION OF DRAWINGS

The above and other aspects, features, and advantages of embodiments of the disclosure will be more apparent from the following detailed description, taken in conjunction with the accompanying drawings, in which:

FIGS. 1 to 3 are diagrams illustrating examples of an aerosol generating article inserted into an aerosol generating device, according to an embodiment.

FIGS. 4 and 5 are diagrams illustrating examples of an aerosol generating article according to an embodiment.

FIG. 6 is a block diagram of an aerosol generating device according to an embodiment.

FIG. 7 is a diagram illustrating an aerosol generating device according to an embodiment.

FIG. 8 is a diagram illustrating a wick according to an embodiment.

FIG. 9 is a diagram illustrating a wick according to another embodiment.

FIG. 10 is a diagram illustrating a wick according to another embodiment.

FIG. 11 is a diagram illustrating a wick according to another embodiment.

FIG. 12 is a diagram illustrating a wick according to another embodiment.

FIG. 13 is a perspective view of a heating element according to an embodiment.

FIG. 14 is a plan view of a heating element according to an embodiment.

FIG. 15 is a cross-sectional view of the heating element of FIG. 14, taken along a line 15-15, according to an embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood throughout the whole specification that, when one part “includes” or “comprises” one component, the part does not exclude other components but may further include other components, unless the context clearly dictates otherwise. Also, terms such as “unit,” “module,” etc., as used in the specification may refer to a part for processing at least one function or operation, which may be implemented as hardware, software, or a combination of hardware and software.

Hereinbelow, embodiments of the disclosure will be described in detail with reference to the accompanying drawings so that the embodiments may be readily implemented by one of ordinary skill in the art to which the present disclosure pertains. However, the disclosure may be implemented in many different forms and is not limited to the embodiments described herein.

Hereinafter, embodiments of the disclosure are described in detail with reference to the drawings.

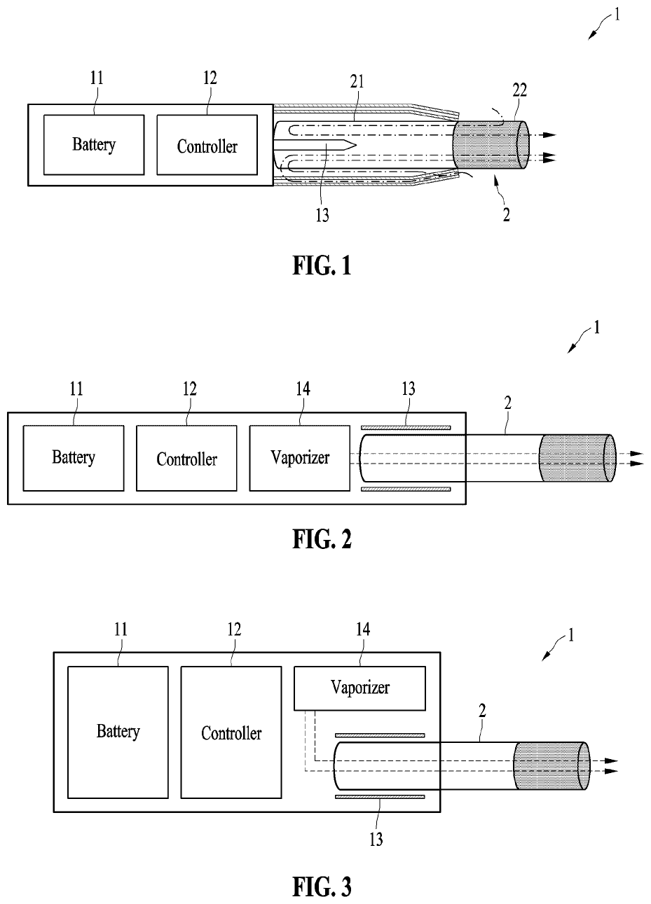

FIGS. 1 to 3 are diagrams illustrating examples of an aerosol generating article inserted into an aerosol generating device.

Referring to FIG. 1, an aerosol generating device 1 may include a battery 11, a controller 12, and a heater 13. Referring to FIGS. 2 and 3, the aerosol generating device 1 may further include a vaporizer 14. In addition, an aerosol generating article 2 (e.g., a cigarette) may be inserted into an inner space of the aerosol generating device 1.

The aerosol generating device 1 shown in FIGS. 1 to 3 may include components related to the embodiments described herein. Therefore, it is to be understood by one of ordinary skill in the art to which the disclosure pertains that the aerosol generating device 1 may further include other general-purpose components in addition to the components shown in FIGS. 1 to 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, an internal structure of the aerosol generating device 1 is not limited to the illustration in FIGS. 1 to 3. That is, the alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into a user.

Even when the aerosol generating article 2 is not inserted into the aerosol generating device 1, the aerosol generating device 1 may heat the heater 13 as needed.

The battery 11 may supply power to be used to operate the aerosol generating device 1. For example, the battery 11 may supply power to heat the heater 13 or the vaporizer 14 and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates or as a combination of a general-purpose microprocessor and a memory in which a program executable by the microprocessor is stored. In addition, it is to be understood by one of ordinary skill in the art to which the present disclosure pertains that the processor may be implemented in other types of hardware.

The heater 13 may be heated by the power supplied by the battery 11. For example, when an aerosol generating article 2 is inserted into the aerosol generating device 1, the heater 13 may be disposed outside the aerosol generating article 2. The heater 13 that is heated may thus raise the temperature of an aerosol generating material in the aerosol generating article 2.

The heater 13 may be an electrically resistive heater. For example, the heater 13 may include an electrically conductive track, and the heater 13 may be heated as a current flows through the electrically conductive track. However, the heater 13 is not limited to the above-described example, and any example of heating the heater 13 up to a desired temperature may be applicable without limitation. Here, the desired temperature may be preset in the aerosol generating device 1 or may be set by the user.

In another example, the heater 13 may be an induction heater. Specifically, the heater 13 may include an electrically conductive coil for heating the aerosol generating article 2 in an induction heating manner, and the aerosol generating article 2 may include a susceptor to be heated by the induction heater.

For example, the heater 13 may include a tubular heating element, a plate-shaped heating element, a needle-shaped heating element, or a rod-shaped heating element and may heat the inside or outside of the aerosol generating article 2 according to the shape of a heating element.

In addition, the heater 13 may be provided as a plurality of heaters in the aerosol generating device 1. In this case, the plurality of heaters 13 may be disposed to be inserted into the aerosol generating article 2 or may be disposed outside the aerosol generating article 2. In addition, some of the plurality of heaters 13 may be disposed to be inserted into the aerosol generating article 2, and the rest may be disposed outside the aerosol generating article 2. However, the shape of the heater 13 is not limited to the illustration in FIGS. 1 to 3, and the heater 13 may be manufactured in various other shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path of the aerosol generating device 1 may be configured such that the aerosol generated by the vaporizer 14 may pass through the aerosol generating article 2 into the user.

For example, the vaporizer 14 may include a liquid storage (e.g., a reservoir), a liquid transfer means, and a heating element. However, embodiments are not limited thereto. For example, the liquid storage, the liquid transfer means, and the heating element may be included as independent modules in the aerosol generating device 1.

The liquid storage may store the liquid composition. The liquid composition may be, for example, a liquid including a tobacco-containing material that includes a volatile tobacco flavor component or a liquid including a non-tobacco material. The liquid storage may be manufactured to be detachably attached to the vaporizer 14 or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E. However, embodiments are not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire and may be arranged in a structure wound around the liquid transfer means. The heating element may be heated as a current is supplied, may transfer heat to the liquid composition in contact with the heating element, and may thus heat the liquid composition. As a result, an aerosol may be generated.

For example, the vaporizer 14 may also be referred to as a cartomizer or an atomizer. However, embodiments are not limited thereto.

The aerosol generating device 1 may further include general-purpose components in addition to the battery 11, the controller 12, the heater 13, and the vaporizer 14. The aerosol generating device 1 may include, for example, a display that outputs visual information and/or a motor that outputs tactile information. In addition, the aerosol generating device 1 may include at least one sensor (e.g., a puff sensor, a temperature sensor, an insertion detection sensor for an aerosol generating article 2, etc.). In addition, the aerosol generating device 1 may be manufactured to have a structure allowing external air to be introduced or internal gas to flow out even while the aerosol generating article 2 is inserted.

Although not shown in FIGS. 1 to 3, the aerosol generating device 1 may constitute a system along with a separate cradle. For example, the cradle may be used to charge the battery 11 of the aerosol generating device 1. Alternatively, the heater 13 may be heated in a state in which the cradle and the aerosol generating device 1 are coupled.

The aerosol generating article 2 may be similar to a conventional combustible cigarette. For example, the aerosol generating article 2 may be divided into a first portion including an aerosol generating material and a second portion including a filter or the like. Alternatively, the second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed to the outside. Alternatively, only a part of the first portion may be inserted into the aerosol generating device 1, or the entirety of the first portion and part of the second portion may be inserted into the aerosol generating device 1. The user may inhale the aerosol with the second portion in their mouth. In this case, the aerosol may be generated as external air passes through the first portion, and the generated aerosol may pass through the second portion and be transferred into the mouth of the user.

For example, the external air may be introduced through at least one air path formed in the aerosol generating device 1. In this example, the opening or closing and/or the size of the air path formed in the aerosol generating device 1 may be adjusted by the user. Accordingly, an amount of atomization, a sense of smoking, or the like may be adjusted by the user. In another example, the external air may be introduced into the inside of the aerosol generating article 2 through at least one hole formed in a surface of the aerosol generating article 2.

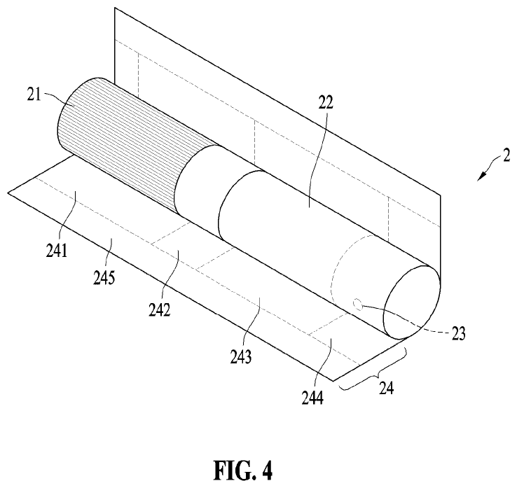

Hereinafter, examples of the aerosol generating article 2 are described with reference to FIGS. 4 and 5.

FIGS. 4 and 5 are diagrams illustrating examples of an aerosol generating article.

Referring to FIG. 4, the aerosol generating article 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

The diameter of the aerosol generating article 2 may be in a range of 5 millimeters (mm) to 9 mm, and the length of the aerosol generating article 2 may be about 48 mm. However, embodiments are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas flows out. For example, the aerosol generating article 2 may be wrapped with one wrapper 24. In another example, the aerosol generating article 2 may be wrapped with two or more wrappers 24 in an overlapping manner. For example, the tobacco rod 21 may be wrapped with a first wrapper 241, and the filter rod 22 may be wrapped with wrappers (e.g., a second wrapper 242, a third wrapper 243, and a fourth wrapper 244). In addition, the aerosol generating article 2 may be entirely wrapped again with a single wrapper (e.g., a fifth wrapper 245). For example, when the filter rod 22 includes a plurality of segments, the plurality of segments may be respectively wrapped with the wrappers (e.g., the second wrapper 242, the third wrapper 243, and the fourth wrapper 244).

The first wrapper 241 and the second wrapper 242 may be manufactured from general filter wrapping paper. For example, the first wrapper 241 and the second wrapper 242 may be porous wrapping paper or non-porous wrapping paper. In addition, the first wrapper 241 and the second wrapper 242 may be manufactured from oilproof paper and/or an aluminum-laminated wrapping material.

The third wrapper 243 may be manufactured from hard wrapping paper. For example, the basis weight of the third wrapper 243 may be in a range of 88 grams per square meter (g/m²) to 96 g/m² and may desirably be in a range of 90 g/m² to 94 g/m². In addition, the thickness of the third wrapper 243 may be in a range of 120 micrometers (um) to 130 μm and may desirably be 125 μm.

The fourth wrapper 244 may be manufactured from oilproof hard wrapping paper. For example, the basis weight of the fourth wrapper 244 may be in a range of 88 g/m² to 96 g/m² and may desirably be in a range of 90 g/m² to 94 g/m². In addition, the thickness of the fourth wrapper 244 may be in a range of 120 μm to 130 μm and may desirably be 125 μm.

The fifth wrapper 245 may be manufactured from sterile paper (e.g., MFW). Here, the sterile paper (e.g., MFW) may refer to paper specially prepared such that the paper has enhanced tensile strength, water resistance, smoothness, or the like, compared to general paper. For example, the basis weight of the fifth wrapper 245 may be in a range of 57 g/m² to 63 g/m² and may desirably be 60 g/m². In addition, the thickness of the fifth wrapper 245 may be in a range of 64 μm to 70 μm and may desirably be 67 μm.

The fifth wrapper 245 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the heater 13. Specifically, when the temperature rises above the ignition point of any one of the materials included in the tobacco rod 21, the aerosol generating article 2 may burn. Even in this case, the aerosol generating article 2 may be prevented from burning because the fifth wrapper 245 may include a non-combustible material.

In addition, the fifth wrapper 245 may prevent an aerosol generating device 1 (e.g. a holder) from being contaminated by materials produced in the aerosol generating article 2. Liquid materials may be produced in the aerosol generating article 2 when a user puffs. For example, as an aerosol generated in the aerosol generating article 2 is cooled by external air, such liquid materials (e.g., moisture, etc.) may be produced. As the aerosol generating article 2 is wrapped with the fifth wrapper 245, the liquid materials generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizer that is added by being sprayed onto the tobacco rod 21.

The tobacco rod 21 may be manufactured in various forms. For example, the tobacco rod 21 may be formed as a sheet or a strand. Alternatively, the tobacco rod 21 may be manufactured from tobacco leaves finely cut from a tobacco sheet. In addition, the tobacco rod 21 may be enveloped by a thermally conductive material. The thermally conductive material may be, for example, a metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. Here, although not shown in the drawings, the tobacco rod 21 may further include an additional susceptor in addition to the thermally conductive material enveloping the outside thereof.

The filter rod 22 may be a cellulose acetate filter. However, a shape of the filter rod 22 is not limited. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

The first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

The length or diameter of the second segment may be determined in various ways according to the shape of the aerosol generating article 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber made of a polymer. Alternatively, the second segment may be manufactured by weaving a separate fiber to which a flavoring liquid is applied and the fiber made of the polymer together. Alternatively, the second segment may be formed from a crimped polymer sheet.

For example, the polymer may be prepared with a material selected from a group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed from the woven polymer fiber or the crimped polymer sheet, the second segment may include a single channel or a plurality of channels extending in a longitudinal direction of the second segment. A channel used herein may refer to a path through which a gas (e.g., air or aerosol) passes.

For example, the second segment formed from the crimped polymer sheet may be formed from a material having a thickness between about 5 μm and about 300 μm, for example, between about 10 μm and about 250 μm. In addition, the total surface area of the second segment may be between about 300 square millimeters per millimeter (mm^{2/}mm) and about 1000 mm²/mm. Furthermore, an aerosol cooling element may be formed from a material having a specific surface area between about 10 square millimeters per milligram (mm^{2/}mg) and about 100 mm²/mg.

The second segment may include a thread containing a volatile flavor ingredient. The volatile flavor ingredient may be menthol. However, embodiments are not limited thereto. For example, the thread may be filled with an amount of menthol sufficient to provide at least 1.5 mg of menthol to the second segment.

The third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as passing through the second segment of the filter rod 22, and the cooled aerosol may pass through the third segment into the user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, an aerosol generating article 3 may further include a front end plug 33. The front end plug 33 may be disposed on one side of a tobacco rod 31 opposite to a filter rod 32. The front end plug 33 may prevent the tobacco rod 31 from escaping to the outside and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and the total length of the aerosol generating article 3 may respectively correspond to the diameter and the total length of the aerosol generating article 2 of FIG. 4. For example, the length of the front end plug 33 may be about 7 mm, the length of the tobacco rod 31 may be about 15 mm, the length of the first segment 321 may be about 12 mm, and the length of the second segment 322 may be about 14 mm. However, embodiments are not limited thereto.

The aerosol generating article 3 may be wrapped by at least one wrapper 35. The wrapper 35 may have at least one hole through which external air flows inside or internal gas flows outside. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

In addition, at least one perforation 36 may be formed in the fifth wrapper 355. For example, the perforation 36 may be formed in a region enclosing the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol.

For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and metal foil such as aluminum foil. For example, the total thickness of the first wrapper 351 may be in a range of 45 μm to 55 μm and may desirably be 50.3 μm. Furthermore, the thickness of the metal foil of the first wrapper 351 may be in a range of 6 μm to 7 μm and may desirably be 6.3 um. In addition, the basis weight of the first wrapper 351 may be in a range of 50 g/m² to 55 g/m² and may desirably be 53 g/m².

The second wrapper 352 and the third wrapper 353 may be made of general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Furthermore, the thickness of the second wrapper 352 may be in a range of 70 μm to 80 μm and may desirably be 78 μm. In addition, the basis weight of the second wrapper 352 may be in a range of 20 g/m² to 25 g/m² and may desirably be 23.5 g/m².

For example, the porosity of the third wrapper 353 may be 24000 CU. However, embodiments are not limited thereto. Furthermore, the thickness of the third wrapper 353 may be in a range of 60 μm to 70 μm and may desirably be 68 μm. In addition, the basis weight of the third wrapper 353 may be in a range of 20 g/m² to 25 g/m² and may desirably be 21 g/m².

The fourth wrapper 354 may be made of polylactic acid (PLA) laminated paper. Here, the PLA laminated paper may refer to three-ply paper including a paper layer, a PLA layer, and another paper layer. For example, the thickness of the fourth wrapper 354 may be in a range of 100 μm to 120 μm and may desirably be 110 μm. In addition, the basis weight of the fourth wrapper 354 may be in a range of 80 g/m² to 100 g/m² and may desirably be 88 g/m².

The fifth wrapper 355 may be manufactured from sterile paper (e.g., MFW). Here, the sterile paper (e.g., MFW) may refer to paper specially prepared such that the paper has enhanced tensile strength, water resistance, smoothness, or the like, compared to general paper. For example, the basis weight of the fifth wrapper 355 may be in a range of 57 g/m² to 63 g/m² and may desirably be 60 g/m². Furthermore, the thickness of the fifth wrapper 355 may be in a range of 64 μm to 70 μm and may desirably be 67 μm.

The fifth wrapper 355 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 355 without limitation.

The front end plug 33 may be manufactured from cellulose acetate. For example, the front end plug 33 may be manufactured by adding a plasticizer (e.g., triacetin) to cellulose acetate tow. A mono denier of a filament of the cellulose acetate tow may be in a range of 1.0 to 10.0 and may desirably be in a range of 4.0 to 6.0. A mono denier of the filament of the front end plug 33 may more desirably be 5.0. In addition, a cross section of the filament of the front end plug 33 may be Y-shaped. A total denier of the front end plug 33 may be in a range of 20000 to 30000 and may desirably be in a range of 25000 to 30000. The total denier of the front end plug 33 may more desirably be 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 is omitted here.

The first segment 321 may be manufactured from cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33.

The second segment 322 may be manufactured from cellulose acetate. A mono denier of a filament of the second segment 322 may be in a range of 1.0 to 10.0 and may desirably be in a range of 8.0 to 10.0. The mono denier of the filament of the second segment 322 may more desirably be 9.0. In addition, a cross section of the filament of the second segment 322 may be Y-shaped. A total denier of the second segment 322 may be in a range of 20000 to 30000 and may desirably be 25000.

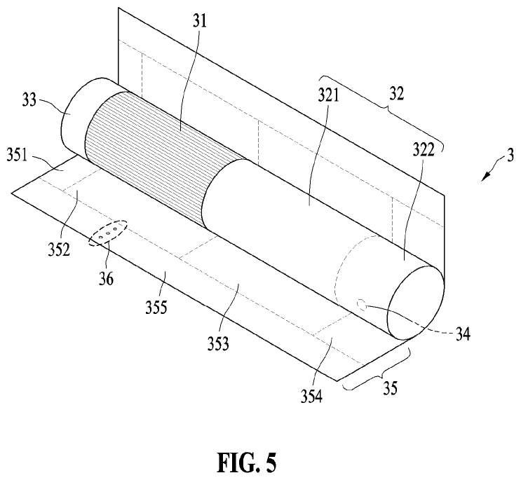

FIG. 6 is a block diagram of an aerosol generating device 400 according to an embodiment.

The aerosol generating device 400 may include a controller 410, a sensing unit 420, an output unit 430, a battery 440, a heater 450, a user input unit 460, a memory 470, and a communication unit 480. However, an internal structure of the aerosol generating device 400 is not limited to the illustration in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400 and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted into the aerosol generating device 400, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may function as a temperature sensor. Alternatively, the temperature sensor 422 may be arranged around the battery 440 to monitor the temperature of the battery 440.

The insertion detection sensor 424 may sense whether the aerosol generating article is inserted into and/or removed from the aerosol generating device 400. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors (e.g., the temperature sensor 422, the insertion detection sensor 424, and the puff sensor 426) described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display (LCD) panel, an organic light-emitting display (OLED) panel, or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, which converts the power of the battery 440 and supplies the power to respective components.

In an embodiment, the heater 450 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating element, or the like. However, embodiments are not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating an aerosol generating article and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect type, etc.), a jog wheel, a jog switch, or the like. However, embodiments are not limited thereto. In addition, although not shown in FIG. 6, the aerosol generating device 400 may further include a connection interface, such as a universal serial bus (USB) interface, and may be connected to another external device through the connection interface such as a USB interface to transmit and receive information to and from the external device or to charge the battery 440.

The memory 470, which is hardware for storing various pieces of data processed in the aerosol generating device 400, may store data processed by the controller 410 and data to be processed by the controller 410. The memory 470 may include at least one type of storage medium of flash memory type memory, hard disk type memory, multimedia card micro type memory, card type memory (e.g., an SD or XD memory), random access memory (RAM), static random-access memory (SRAM), read-only memory (ROM), electrically erasable programmable read-only memory (EEPROM), programmable read-only memory (PROM), magnetic memory, a magnetic disk, or an optical disk. The memory 470 may store an operating time of the aerosol generating device 400, the maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a Bluetooth low energy (BLE) communication unit, a near field communication unit, a wireless local area network (WLAN) communication unit (e.g., Wi-Fi), a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communication unit, an Internet communication unit, a computer network (e.g., a LAN or a wide-area network (WAN)) communication unit, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The processor may be implemented as an array of a plurality of logic gates or as a combination of a general-purpose microprocessor and a memory in which a program executable by the microprocessor is stored. In addition, it is to be understood by one of ordinary skill in the art to which the disclosure pertains that the processor may be implemented in other types of hardware.

The controller 410 may control the temperature of the heater 450 by controlling the supply of power from the battery 440 to the heater 450. For example, the controller 410 may control the supply of power to the heater 450 by controlling switching of a switching element between the battery 440 and the heater 450. In another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. In another example, the controller 410 may control the amount of power to be supplied to the heater 450 and the time for which the power is to be supplied such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the operation of the aerosol generating device 400 is to be ended soon, through at least one of the display 432, the haptic portion 434, or the sound outputter 436.

In an embodiment, the controller 410 may control the power supply time and/or the power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes a computer-readable command, a data structure, or other data regarding a modulated data signal such as a program module, or other transmission mechanisms, and includes any information transfer medium.

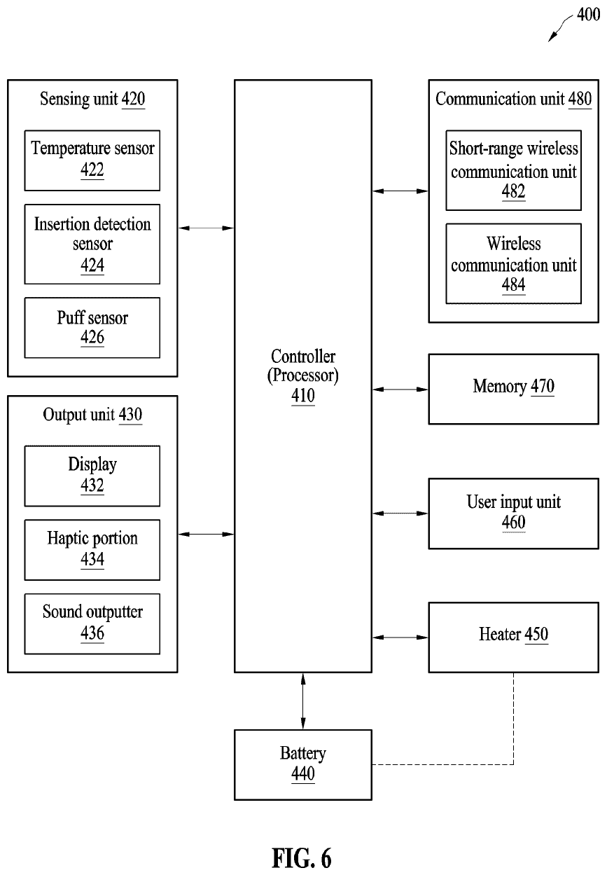

FIG. 7 is a diagram illustrating an aerosol generating device according to an embodiment.

Referring to FIG. 7, an aerosol generating device 500 (e.g., the aerosol generating device 1 of FIGS. 1 to 3 and/or the aerosol generating device 400 of FIG. 6) may include a housing 510. The housing 510 may include a first end portion 510A (e.g., a mouth end portion), a second end portion 510B (e.g., a device end portion) opposite to the first end portion 510A, and an extension 510C between the first end portion 510A and the second end portion 510B.

In an embodiment, the width or diameter of the first end portion 510A may be less than the width or diameter of the extension 510C. In an embodiment not shown, the diameter or width of the first end portion 510A may be substantially the same as the diameter or width of the extension 510C.

In an embodiment, the housing 510 may include a reservoir 512 (e.g., a liquid reservoir). The reservoir 512 may be configured to store a liquid composition 513. The reservoir 512 may be disposed adjacent to the first end portion 510A.

In an embodiment, the reservoir 512 may include a passage 510D leading to the first end portion 510A. The reservoir 512 may include, for example, a substantially cylindrical shape. The passage 510D may be disposed in a central portion of the reservoir 512. The aerosol may flow out of the housing 510 through the first end portion 510A along the passage 510D.

In an embodiment, the housing 510 may include a single reservoir 512.

In an embodiment, the housing 510 may include a plurality of reservoirs 512. For example, the housing 510 may include a first reservoir 512A and a second reservoir 512B. The first reservoir 512A may be disposed on a first side of the extension 510C, and the second reservoir 512B may be disposed on a second side opposite to the first side of the extension 510C. The first reservoir 512A and the second reservoir 512B may be spaced apart while facing each other. The first reservoir 512A and the second reservoir 512B may form the passage 510D.

In an embodiment, the reservoir 512 may be detachably coupled to the housing 510. The reservoir 512 may be replaced with a new reservoir (not shown).

In an embodiment, the housing 510 may include a chamber 510E. The chamber 510E may be communicatively connected to the passage 510D. The width of the chamber 510E may be greater than the width of the passage 510D. In an embodiment, the chamber 510E may be disposed in the central portion of the single reservoir 512. In an embodiment, the chamber 510E may be disposed between the first reservoir 512A and the second reservoir 512B.

In an embodiment, the aerosol generating device 500 may include a controller 520 (e.g., the controller 12 of FIGS. 1 to 3 and/or the controller 410 of FIG. 6).

In an embodiment, the aerosol-generating device 500 may include a battery 530 (e.g., the battery 11 of FIGS. 1 to 3 and/or the battery 440 of FIG. 6).

In an embodiment, the aerosol generating device 500 may include a light source 540. The light source 540 may be configured to generate light. For example, the light source 540 may include at least one of a light emitting diode (LED), a laser light source, or any suitable light generating device, or a combination thereof.

In an embodiment, the aerosol generating device 500 may not include the light source 540. The aerosol generating device 500 may use external light of the housing 510.

In an embodiment, the light source 540 may be configured to transmit light in an ultraviolet band, a visible band (e.g., about 380 nanometers (nm) to about 780 nm), and/or an infrared band.

In an embodiment, the light source 540 may be configured to generate light having a wavelength for generating surface plasmon resonance (SPR) of metal particles. For example, the light source 540 may transmit light in a wavelength band corresponding to an average maximum absorbance according to the type of metal particles. In an embodiment in which the metal particles are gold (Au), the light source 540 may generate light having a wavelength of about 600 nm to about 650 nm. In an embodiment in which the metal particles are silver (Ag), the light source 540 may generate light having a wavelength of about 420 nm to about 470 nm.

In an embodiment, the aerosol generating device 500 may include a plurality of light sources 540. The plurality of light sources 540 may be implemented as light sources of the same type. In an embodiment, at least a portion of the plurality of light sources 540 may be implemented as different types of light sources.

In an embodiment, the plurality of light sources 540 may be configured to emit light substantially at the same time. In an embodiment, the plurality of light sources 540 may be configured to emit light at different times.

In an embodiment, the plurality of light sources 540 may be configured to emit light for substantially the same period of time. In an embodiment, an irradiation time of one light source 540 of the plurality of light sources 540 may be different from an irradiation time of another light source 540.

In an embodiment, the plurality of light sources 540 may be configured to generate light of substantially the same wavelength band. In an embodiment, a wavelength band of light generated from one of the plurality of light sources 540 may be different from a wavelength band of light generated from another light source 540.

In an embodiment, the plurality of light sources 540 may be configured to generate light of substantially the same illuminance. In an embodiment, an illuminance of any one light source 755 of the plurality of light sources 540 may be different from an illuminance of another light source 540.

In an embodiment, the aerosol generating device 500 may include a wick 550. The wick 550 may be configured to transfer the liquid composition from the reservoir 512 to a heating element 560 (e.g., the heater 13 of FIGS. 1 to 3 and/or the heater 450 of FIG. 4). The wick 550 may include a first end portion 550A (e.g., a first wick end portion), a second end portion 550B (e.g., a second wick end portion) opposite to the first end portion 550A, and an extension 550C extending between the first end portion 550A and the second end portion 550B.

In an embodiment, the first end portion 550A and the second end portion 550B may be disposed in the reservoir 512. In an embodiment, the first end portion 550A may be disposed in the first reservoir 512A and the second end portion 550B may be disposed in the second reservoir 512B.

In an embodiment, the first end portion 550A may be connected to a first portion of the reservoir 512 and the second end portion 550B may be connected to a second portion other than the first portion of the reservoir 512. For example, the first end portion 550A may be connected to the first reservoir 512A and the second end portion 550B may be connected to the second reservoir 512B.

In an embodiment, at least a portion of the extension 550C may be disposed in the chamber 510E. In an embodiment, at least a portion of the extension 550C may be disposed in the reservoir 512. In an embodiment, at least a portion of the extension 550C may be disposed in the first reservoir 512A and/or in the second reservoir 512B.

In an embodiment, the aerosol generating device 500 may include the heating element 560. The heating element 560 may be configured to generate heat. In an embodiment, the heating element 560 may be configured to generate heat by SPR. “SPR” refers to collective oscillations of electrons propagating along an interface of metal particles with a medium. For example, the collective oscillation of electrons of metal particles may be caused by light propagating from the outside (e.g., a light source 540) of the heating element 560. The excitation of electrons of metal particles may generate thermal energy, and the generated thermal energy may be transferred within an environment to which the heating element 560 is applied. In an embodiment, the heating element 560 may be included in the wick 550. For example, the heating element 560 may be disposed in the extension 550C.

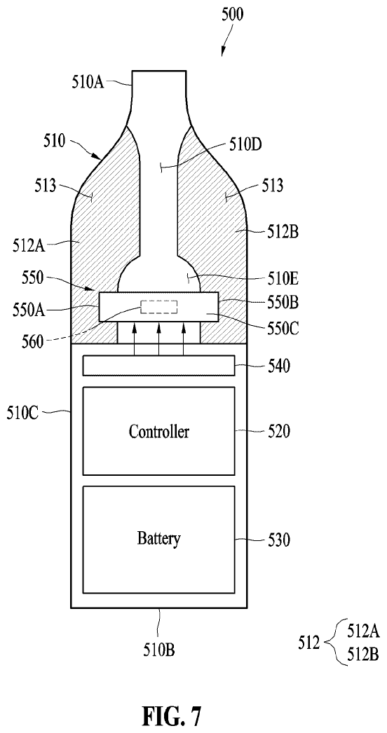

FIG. 8 is a diagram illustrating a wick according to an embodiment.

Referring to FIG. 8, the wick 550 may include the extension 550C. The extension 550C may include a plurality of fiber strands 551. The plurality of fiber strands 551 may be entangled with each other. The plurality of fiber strands 551 may be predominantly aligned in a manner that appears essentially parallel between the first end portion (e.g., the first end portion 550A of FIG. 7) and the second end portion (e.g., the second end portion 550B of FIG. 7) of the wick 550. Here, “essentially parallel” implies that the fiber strands 551 are not precisely parallel but exhibit a wavy configuration resulting from their entanglement with each other.

In an embodiment, the plurality of fiber strands 551 may include cotton materials. In an embodiment, the plurality of fiber strands 551 may include silica materials.

In an embodiment, the wick 550 may include an opening 552. The opening 552 may be formed in a side surface of the extension 550C. The opening 552 may have any size and/or shape suitable to allow passage of light from the outside of the wick 550 to the inside of the wick 550.

In an embodiment, the wick 550 may include the heating element 560. The heating element 560 may be embedded in the extension 550C. The heating element 560 may be surrounded by a plurality of fiber strands 551. Heat generated from the heating element 560 may be transferred in substantially all directions inside the wick 550. The liquid composition absorbed by the plurality of fiber strands 551 and/or the liquid composition present in the space between the plurality of fiber strands 551 may make a phase change into an aerosol by heat generated from the heating element 560. The structure in which the heating element 560 is disposed in the wick 550 may increase atomization efficiency.

In an embodiment, the heating element 560 may include a substrate 561. The substrate 561 may include a first substrate surface 561A, a second substrate surface 561B opposite to the first substrate surface 561A, and a plurality of side substrate surfaces 561C between the first substrate surface 561A and the second substrate surface 561B. The first substrate surface 561A may face the opening 552. In an embodiment, the substrate 561 may include various heat transfer materials. For example, the substrate 561 may include at least one of glass, stainless steel, or other heat transfer materials, or a combination thereof.

In an embodiment, the length or width of the substrate 561 may be greater than the width or diameter of the opening 552. In an embodiment not shown, the length or width of the substrate 561 may be substantially the same as the width or diameter of the opening 552.

In an embodiment, the heating element 560 may include a metal layer 562. The metal layer 562 may include a first layer 562A. The first layer 562A may be disposed on the first substrate surface 561A. In an embodiment, the metal layer 562 may include a second layer 562B. The second metal layer 562B may be disposed on the second substrate surface 561B. In an embodiment, the metal layer 562 may include a plurality of third layers 562C. The plurality of third layers 562C may be respectively disposed on the corresponding side substrate surfaces 561C.

In an embodiment, the metal layer 562 may include a plurality of metal particles 563. The plurality of metal particles 563 may include, for example, at least one of gold, silver, platinum, palladium, or any metal material suitable for generating heat by SPR, or a combination thereof.

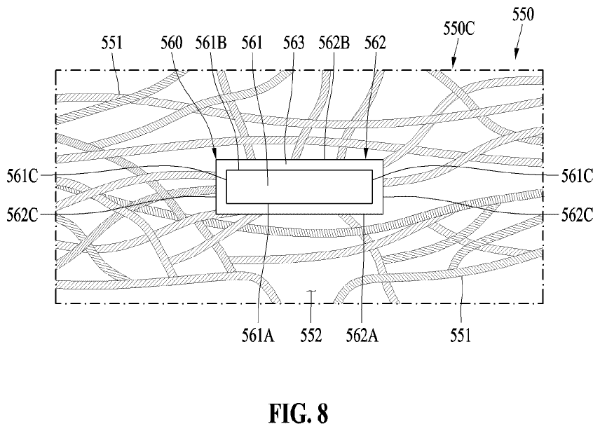

FIG. 9 is a diagram illustrating a wick according to another embodiment.

Referring to FIG. 9, a wick 550-1 (e.g., the wick 550 of FIG. 7) may include the extension 550C. The extension 550C may include a body portion 553 and a hollow portion 554 formed in the body portion 553. The hollow portion 554 may be defined by the body portion 553. In an embodiment, the body portion 553 and the hollow portion 554 may each include a substantially cylindrical shape.

In an embodiment, the body portion 553 may include a metal material. In an embodiment, the body portion 553 may include a ceramic material.

In an embodiment, the extension 550C may include a plurality of pores 555. The plurality of pores 555 may allow the outside of the body portion 553 and the hollow portion 554 to communicate with each other. An aerosol present in the hollow portion 554 may flow out of the body portion 553 through the plurality of pores 555. The plurality of pores 555 may be formed in a side surface of the body portion 553.

In an embodiment, the wick 550 may include an opening 552-1. The opening 552-1 may be formed in the body portion 553. The opening 552-1 may have any size and/or shape suitable to allow passage of light from the outside of the body portion 553 to the hollow portion 554.

In an embodiment, the wick 550 may include the heating element 560. The heating element 560 may be disposed in the hollow portion 554. The heating element 560 may include a substrate 561 and a metal layer 562. The metal layer 562 may include the plurality of metal particles 563.

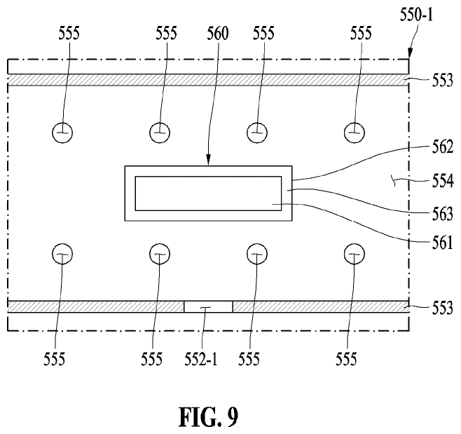

FIG. 10 is a diagram illustrating a wick according to another embodiment.

Referring to FIG. 10, a wick 550-2 (e.g., the wick 550 of FIG. 7) may include the extension 550C. The extension 550C may include the plurality of fiber strands 551, the body portion 553, the hollow portion 554, and a plurality of pores 555. The wick 550-2 may include the opening 552-1. The wick 550-2 may include the heating element 560. The heating element 560 may include the substrate 561 and the metal layer 562. The metal layer 562 may include the plurality of metal particles 563. In an embodiment, the plurality of fiber strands 551 may surround the heating element 560. The plurality of fiber strands 551 may be disposed in the hollow portion 554.

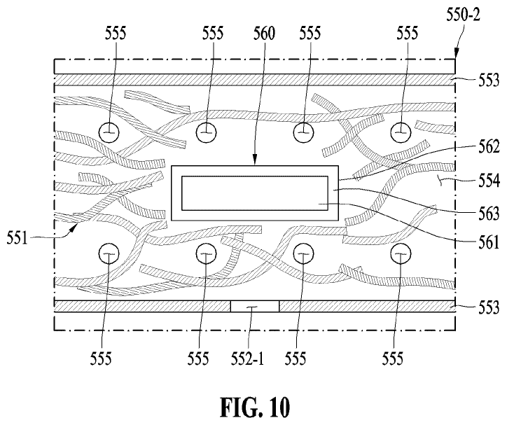

FIG. 11 is a diagram illustrating a wick according to another embodiment.

Referring to FIG. 11, a wick 550-3 (e.g., the wick 550 of FIG. 7) may include the extension 550C. The extension 550C may include the body portion 553, the hollow portion 554, and the plurality of pores 555. The wick 550-3 may include the opening 552-1. The wick 550-3 may include the heating element 560. The heating element 560 may include the substrate 561 and the metal layer 562. The metal layer 562 may include the plurality of metal particles 563.

In an embodiment, the wick 550-3 may include a light collector 570. The light collector 570 may be configured to concentrate light onto a specific area (e.g., a partial area of the metal layer 562) of the heating element 560. The light collector 570 may include, for example, a convex lens. The light collector 570 may be disposed in the opening 552-1.

In an embodiment, the wick 550-3 may include a reflector 580. The reflector 580 may be configured to reflect light toward the heating element 560. The reflector 580 may be formed on the inner surface of the body portion 553.

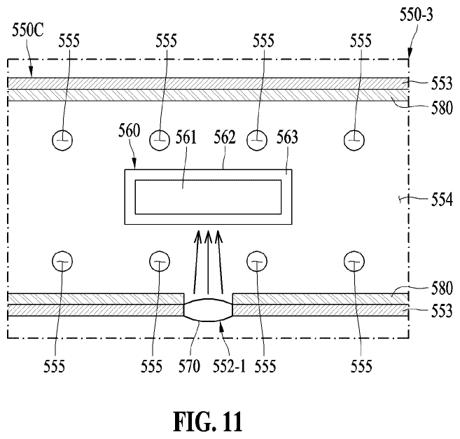

FIG. 12 is a diagram illustrating a wick according to another embodiment.

Referring to FIG. 12, a wick 550-4 (e.g., the wick 550 of FIG. 7) may include the extension 550C. The extension 550C may include the body portion 553, the hollow portion 554, and the plurality of pores 555. The wick 550-3 may include the opening 552-1. The wick 550-3 may include the heating element 560. The heating element 560 may include the substrate 561 and the metal layer 562. The metal layer 562 may include the plurality of metal particles 563. The wick 550-3 may include the reflector 580.

In an embodiment, the wick 550-4 may include a light diffuser 571. The light diffuser 571 may be configured to diffuse light to substantially the entire area of the heating element 560 (e.g., the entire area of the metal layer 562). The light diffuser 571 may include, for example, a concave lens. The light diffuser 571 may be disposed in the opening 552-1.

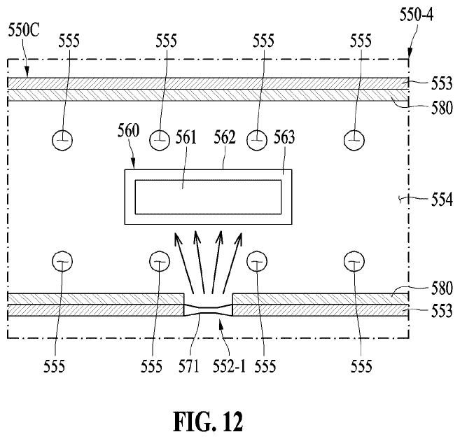

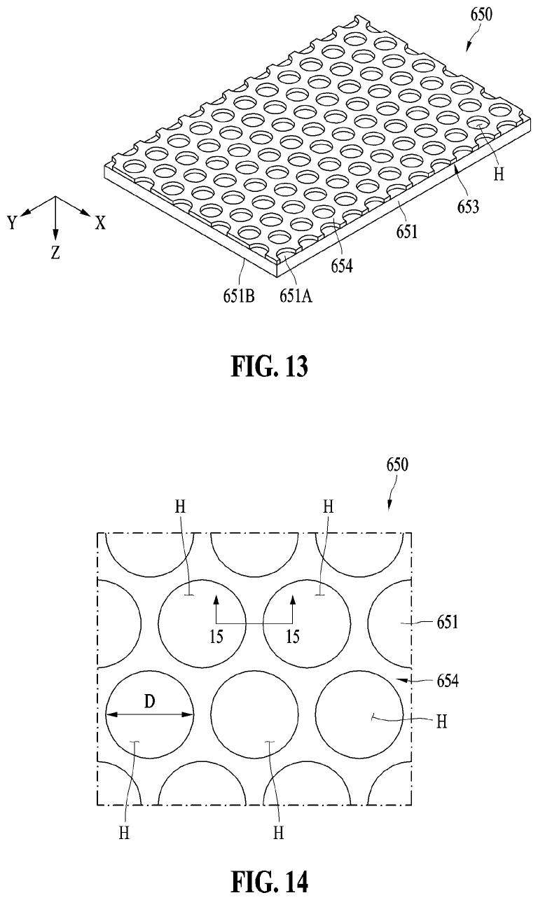

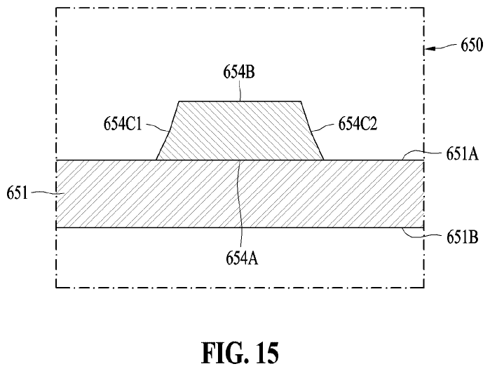

FIG. 13 is a perspective view of a heating element according to an embodiment. FIG. 14 is a plan view of a heating element according to an embodiment. FIG. 15 is a cross-sectional view of the heating element of FIG. 14, taken along a line 15-15, according to an embodiment.

Referring to FIGS. 13 to 15, a heating element 650 may include a substrate 651 (e.g., the substrate 561 of FIGS. 8 to 12) and a metal prism 654 including the plurality of metal particles 653. The substrate 651 may include a first substrate surface 651A (e.g., the first substrate surface 561A of FIG. 8) and a second substrate surface 651B (e.g., the second substrate surface 561B) opposite to the first substrate surface 651A.

In an embodiment, the substrate 651 may include various materials. For example, the substrate 551 may include at least one of glass, silicon (Si), silicon oxide (SiO₂), sapphire, polystyrene, or polymethyl methacrylate, or a combination thereof.

In an embodiment, the substrate 651 may include an electrically conductive material. In an embodiment, the substrate 651 may include an electrically insulating material.

According to embodiments, the substrate 651 may have various thermal conductivities. For example, the substrate 651 may have a thermal conductivity of about 0.6 Watts per meter-Kelvin (W/mK) or less, about 1 W/mK to about 2 W/mK, about 2 W/mK to about 5 W/mK, about 5 W/mK to about 10 W/mK, about 10 W/mK to about 100 W/mK, or about 100W/mK to about 200 W/mK, under a pressure of 1 bar and at a temperature of 25° C.

In an embodiment, the heating element 650 may include a plurality of metal particles 653 (e.g., the metal particles 563 of FIGS. 8 to 12). The plurality of metal particles 653 may be nanoscale. For example, the plurality of metal particles 653 may have an average maximum diameter of about 1 μm or less. In an embodiment, the plurality of metal particles 653 may have an average maximum diameter of about 700 nm or less, about 600 nm or less, about 500 nm or less, about 400 nm or less, about 300 nm or less, about 200 nm or less, about 150 nm or less, or about 100 nm or less.

In an embodiment, the plurality of metal particles 653 may be formed of any material suitable for generating heat. For example, the plurality of metal particles 653 may include at least one of gold, silver, copper, palladium, platinum, aluminum, titanium, nickel, chromium, iron, cobalt, manganese, rhodium, or ruthenium, or a combination thereof.

In an embodiment, the plurality of metal particles 653 may be formed of any material suitable for generating heat by interacting with light of a determined wavelength band (e.g., a visible light wavelength band, that is, about 380 nm to about 780 nm). For example, the plurality of metal particles 653 may include at least one of gold, silver, copper, palladium, and platinum, or a combination thereof.

In an embodiment, the plurality of metal particles 653 may be formed of a metal material having an average maximum absorbance. The average maximum absorbance may be defined as an absorbance substantially having a peak in a wavelength band. A wavelength band in which the plurality of metal particles 653 resonate may include a wavelength band corresponding to an average maximum absorbance. The plurality of metal particles 653 may be formed of a metal material having an average maximum absorbance in a wavelength band between about 430 nm and about 450 nm, between about 480 nm and about 500 nm, between about 490 nm and about 510 nm, between about 500 nm and about 520 nm, between about 550 nm and about 570 nm, between about 600 nm and about 620 nm, between about 620 nm and about 640 nm, between about 630 nm and about 650 nm, between about 640 nm and about 660 nm, between about 680 nm and about 700 nm, or between about 700 nm and about 750 nm. The average maximum absorbance of the plurality of metal particles 653 may vary depending on the type of metal material, the type of the substrate 651, the size of a structure (e.g., a metal prism) formed by the plurality of metal particles 653, and/or the shape of the structure. For example, gold may have a maximum absorbance in a wavelength band of about 600 nm to about 650 nm. For example, silver may have a maximum absorbance in a wavelength band of about 420 nm to about 470 nm.

In an embodiment, the deposition thickness of the plurality of metal particles 653 may be about 10 nm or less. When the plurality of metal particles 653 are deposited on the substrate 651 to have a thickness greater than 10 nm, an exothermic reaction may be reduced in the structure (e.g., the metal prism) formed by the plurality of metal particles 653. When the thickness of the structure formed by the plurality of metal particles 653 exceeds 10 nm, the possibility of heat being lost to the surroundings of the heating structure 650 may increase, and thus, the thermal efficiency of the heating structure 650 may decrease.

The metal prism 654 may be formed as a substantially single structure. The metal prism 654 may include a plurality of holes H.

In an embodiment, the metal prism 654 may include a first base surface 654A (see FIG. 15) facing the first substrate surface 651A of the substrate 651, a second base surface 654B opposite to the first base surface 654A, and a plurality of side surfaces 654C1 and 654C2 between the first base surface 654A and the second base surface 654B. The first substrate surface 651A and the plurality of side surfaces 654C1 and 654C2 may define the plurality of holes H.

In an embodiment, the first base surface 654A and the second base surface 654B may be substantially parallel to each other.

In an embodiment, the first base surface 654A and/or the second base surface 654B may be formed as a substantially flat surface.

In an embodiment, the distance (e.g., the thickness of the metal prism 654) between the first base surface 654A and the second base surface 654B may be about 10 nm or less. When the metal prism 654 has a thickness exceeding 10 nm, the exothermic reaction of a plurality of metal particles forming the metal prism 654 may decrease, and consequently, the thermal efficiency of the heating structure 650 may decrease.

In an embodiment, the plurality of side surfaces 654C1 and 654C2 of the metal prism 654 may be oriented in different directions. For example, the first side surface 654C1 may be oriented in a first direction (e.g., a first radial direction), and the second side surface 654C2 may be oriented in a second direction (e.g., a second radial direction) substantially opposite to the first direction.

In an embodiment, at least one side surface of the plurality of side surfaces 654C1 and 654C2 may be formed as a substantially curved surface. In an embodiment, the plurality of side surfaces 654C1 and 654C2 may be formed as curved surfaces having substantially the same curvature. In an embodiment, among the plurality of side surfaces 654C1 and 654C2, the curvature of one side surface may be different from the curvature of another side surface.

In an embodiment, the plurality of side surfaces 654C1 and 654C2 may be formed as curved surfaces that are concave toward the center of the metal prism 654. In an embodiment, at least one side surface of the plurality of side surfaces 654C1 and 654C2 may be formed as a curved surface that is convex from the center of the metal prism 654.

In an embodiment, the metal prism 654 may include two side surfaces. For example, the metal prism 654 may have a substantially semicircular shape or a shape similar to a semicircle.

In an embodiment, some of the plurality of holes H may be separated from each other by the metal prism 654. In an embodiment, some of the plurality of holes H may be connected to each other.

In an embodiment, the plurality of holes H may have an average maximum diameter D of about 10 nm or greater, about 50 nm or greater, about 90 nm or greater, about 100 nm or greater, about 150 nm or greater, about 200 nm or greater, about 300 nm or greater, about 350 nm or greater, about 450 nm or greater, or about 500 nm or greater.

In an embodiment, the plurality of holes H may have an average maximum diameter D of about 1,000 nm or less, about 900 nm or less, about 800 nm or less, about 700 nm or less, about 600 nm or less, or about 550 nm or less.

The features and aspects of any embodiment(s) described above may be combined with features and aspects of any other embodiment(s) without resulting in apparent technical conflicts.

1. A wick for an aerosol generating device, comprising:
a first end portion;
a second end portion opposite to the first end portion;
an extension extending between the first end portion and the second end portion; and
a heating element disposed inside the extension and configured to generate heat by surface plasmon resonance (SPR).

2. The wick of claim 1, wherein
the extension comprises a plurality of fiber strands, and
the heating element is surrounded by the plurality of fiber strands.

3. The wick of claim 1, wherein the extension comprises:
a hollow portion; and
a body portion that defines the hollow portion, and
wherein the heating element is disposed in the hollow portion.

4. The wick of claim 3, further comprising:
a plurality of fiber strands disposed in the hollow portion and arranged to surround the heating element.

5. The wick of claim 1, further comprising an opening formed in the extension.

6. The wick of claim 5, further comprising a light collector disposed in the opening.

7. The wick of claim 5, wherein further comprising a light diffuser disposed in the opening.

8. The wick of claim 1, wherein the heating element comprises:
a substrate; and
a plurality of metal particles deposited on the substrate.

9. An aerosol generating device comprising:
the wick of claim 1; and
a light source configured to emit light toward the wick.

10. The aerosol generating device of claim 9, further comprising:
a reservoir configured to contain a liquid composition,
wherein at least one end portion of the first end portion or the second end portion is connected to the reservoir.

11. The aerosol generating device of claim 9, further comprising:
a reflector disposed in the extension and configured to reflect light toward the heating element.
